(19) United States
(12) Patent Application Publication
(10) Pub. No.: US 2019/0102845 A1
(43) Pub. Date: Apr. 4, 2019

(54) In-store social media platform

(71) Applicant: FaceStore LLC, Fremont, CA (US)

(72) Inventors: Le Bui, Fremont, CA (US); David Ushijima, Berkeley, CA (US)

(21) Appl. No.: 15/724,276

(22) Filed: Oct. 4, 2017

(51) Int. Cl. G06Q 50/00; G06Q 30/02

(52) U.S. Cl. CPC G06Q 50/01; H04L 67/18; G06Q 30/0267; G06Q 30/0259

(57) ABSTRACT

An in-store platform disposed in a store can include a snap-and-cast feature for the customers inside the store to post messages for viewing by other customers. The in-store platform can also display reviews and recommendation of products and services of the store from users of social media. The in-store platform can also offer activities to increase the engagement of the customers. The in-store platform can promote participation of the customers while inside the store, which can enhance store recognition and retention.

### BACKGROUND

Social media, or sometimes called social networks, can provide the ability to bring people together. Social media can include forms of electronic communication for creating and sharing of information between online communities using data processing systems (such as desktop computers or mobile devices) connected through networks, such as the Internet.

Social media exchanges can take different forms, such as blogs, forums, and products or services review. The contents of the social media can include pictures or videos, text messages or comments, and other forms of data such as tables or graphs.

Social media can include users on mobile devices, which can incorporate user locations and instantaneous responses. Mobile devices can be checked numerous times throughout the day. And there is essentially little or no time lags between responses.

Social media can be used by stores and retailers in their marketing campaigns to reach their customers. Online marketing has been booming in recent years, e.g., targeting marketing campaigns to specific consumers online. However, the physical stores has not seen much progresses from social media, e.g., still limited to static and inefficient advertising and marketing practices.

### SUMMARY OF THE DESCRIPTION

In some embodiments, the present invention discloses an in-store platform to provide an environment for the customers in a store or restaurant to participate or engage in various activities. The platform can include a display, which can serve to send messages to the customers. The platform can include a controller connectable to a network, which can be used for processing incoming communication from the customers, e.g., through their mobile devices connected to the network. The in-store platform can promote participation of the customers while inside the store, which can enhance store recognition and retention. The in-store platform can additionally increase revenues and build customer loyalty for the business through in-store social media promotions and engagement, for example, through various means including the use of promotions.

In some embodiments, the in-store platform can be used as a platform for a local social media, e.g., an in-store social media, with members limited to customers in the store. For example, the in-store social media platform can function as a base for performing social media activities for the customers in the store, and optionally with the store. The store and the customers can generate and participate in discussion of topics interested to the store and to the customers. For example, the customers can ask questions and challenge other customers to a game. The store can post advertisements and discounts, together with other activities to be participated by the customers, such as survey.

In some embodiments, the in-store platform can have a snap-and-cast feature, which can allow customers to take a picture (and/or a video and/or a text message), and send it to the platform to be displayed on the display to be viewed by other customers.

In some embodiments, the in-store platform can be connected to other social media for using discussions and communication from the other social media that are related to the store. For example, the store can show reviews and recommendations from communications of users in other social media, as promotional message to the customers. The in-store platform can also compose advertisements and promotions to be displayed. The communication can include two way communication or interactive communication, e.g., real time communication between the store and its customers.

In some embodiments, the in-store platform can be used as a forum for the customers, with the store acting as a host or with the customers suggesting or providing topics of discussion.

### BRIEF DESCRIPTION OF THE DRAWINGS

FIG. 1 illustrates a simplified schematic of a social media according to some embodiments.

FIG. 2 illustrates a configuration of an in-store social media according to some embodiments.

FIGS. 3A-3B illustrate flowcharts for forming a network of customers in a store according to some embodiments.

FIG. 4 illustrates a configuration of a snap-and-cast feature according to some embodiments.

FIGS. 5A-5C illustrate other configurations of a snap-and-cast feature according to some embodiments.

FIGS. 6A-6B illustrate a configuration of customers participating in a store activity according to some embodiments.

FIG. 7 illustrates a flowchart for forming a system to engage customers in a store according to some embodiments.

FIGS. 8A-8B illustrate flowcharts for performing activities from customers in a store according to some embodiments.

FIG. 9 illustrates a configuration of an in-store platform according to some embodiments.

FIGS. 10A-10B illustrate flowcharts for forming in-store platforms according to some embodiments.

FIG. 11 illustrates a configuration for an in-store platform according to some embodiments.

FIGS. 12A-12B illustrate flowcharts for forming in-store platforms according to some embodiments.

FIGS. 13A-13D illustrate flowcharts for configuring in-store platforms according to some embodiments.

FIG. 14 illustrates an example of a service of an in-store platform according to some embodiments.

FIG. 15 illustrates an example of a service of an in-store platform according to some embodiments.

FIGS. 16A-16B illustrate examples of a service of an in-store platform according to some embodiments.

FIG. 17 illustrates a flowchart for operating a platform to increase engagements of customers according to some embodiments.

### DETAILED DESCRIPTION OF THE EMBODIMENTS

In some embodiments, the present invention discloses an in-store social media, and an in-store social media platform to form the social media activities, that can provide communication between a store and customers in the store. The in-store social media can assist the store to promote the store, e.g., advertising products and services of the store. The in-store social media can be limited to the customers in a vicinity of the store, such as customers already inside the store, or customers thinking about entering the store.

The term “in-store” as used in the present description can mean within a vicinity of a store, such as inside the store, at a nearby store, restaurant or business, or at the entrance of the store. For example, in-store activities can include activities related to the browsing or purchase of products or services of the store while the customers are inside the store. In-store activities can include waiting to be served or enjoying the foods of a food store. Further, in-store activities can include viewing the store at the store entrance, such as browsing the food menu posted outside the store. Thus in-store customers can include current customers or persons who are thinking of becoming customers. The in-store social media platform can reach potential customers who are visiting nearby businesses in the vicinity of the target business. The platform can be implemented with cross promotions between neighboring businesses so as to build customer awareness of neighboring restaurants and retail shops.

The term “store” as used in the present description can mean a physical store, e.g., a place of business such as a restaurant, a bar, or a retailer shop. The term ‘store” can also mean a server, a controller or a platform (such as an in-store social media platform that administers the in-store social media), e.g., a data processing system or a computing device, in a context of social media. For example, a user of an in-store social media can send a communication, e.g., an in-store social media activity, to the store. The term “store” can mean a user of the in-store social media, such as an admin user, that can administer the in-store social media activities. The term “store” can mean a manager or a personnel of the store, who is responsible for the in-store social media activities. The term “store” can mean an in-store social media platform, such as a server that can direct communication in the in-store social media. The term “store” can mean a controller, which can be a computing device or a data processing system, which can be a part of the in-store social media platform.

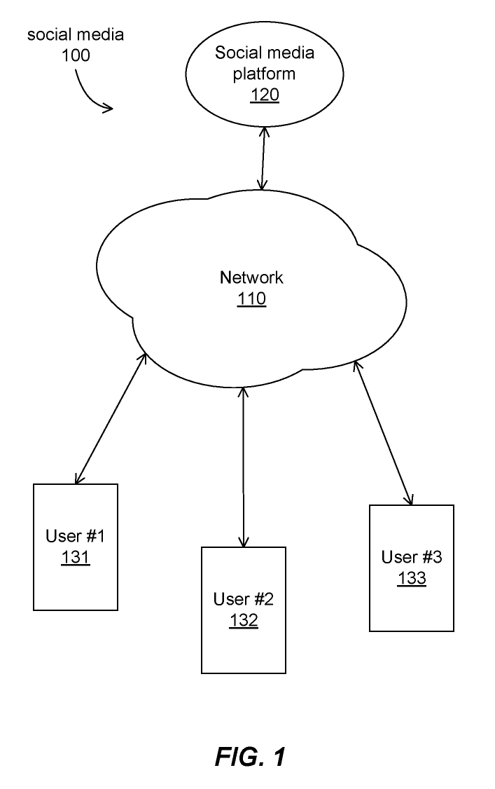

FIG. 1 illustrates a simplified schematic of a social media according to some embodiments. A social media 100 can include a platform having a platform controller 120 connected to a network 110, such as the Internet. The social media 100 can host multiple users 131-133 to participate in discussion and information exchanges through the network 110.

In some embodiments, the social media 100 can be limited to users in a vicinity of a store, e.g., to form an in-store social media. The platform 120 can include a system of the store, located in the store, e.g., inside the store for the customers within the store, and/or at the entrance of the store for the customers browsing the store or thinking about entering the store, or in a cloud server intended for use in the store or in the vicinity of the store. The platform 120 can include a display for communication with the users, and a server to process the traffic between the users and the store. The users 131-133 can use mobile devices to communicate with the platform 120, forming the in-store social media 100. The mobile devices can include devices having a processor with input/output capability that can be portable, such as cell phones, smart phones, tablet computers, handheld computers, personal digital assistants (PDA), virtual reality glasses (VR), augmented reality glasses (AR), and drones

At the premises, a retailer can provide digital signage and static signage systems to engage with the customers in the store. Digital signage systems can include signage that can be changed constantly, such as an electronic display or a monitor (e.g., LCD, LED, or projection display), to display content which are controlled by a data processing system. Static signage systems can include signage that cannot be changed or modified, such as printed posters. In some embodiments, digital signage, e.g., screens, can be provided by a service, and static signage may be provided by the store owner.

In some embodiments, the in-store social media platform can include a digital signage, e.g., a display, together with a controller configured to communicate with local users, e.g., customers or potential customers of a store, through a network. The digital signage can serve as a means of communicating the messages to the users, and the controllers can function to receive communication from the users. The display and the controller can be two separate components, or can be integrated into one component. For example, a display can include a controller for communication with a network.

The in-store social media can manage interaction of the store with current and potential customers, including how to improve business relationships with the customers and how to increase customer retention.

The in-store social media can keep a history of the customers, for example, by the customers making accounts or interacting with the in-store social media, and thus can be identified by the store. The in-store social media can monitor, track, and analyze the customer preferences, e.g., about the products and/or services offered by the store. The store can learn more about the customers and how to best cater to their needs, thus developing stronger relationships with the customers.

The in-store social media platform can be interactive with the customers and can be easy for the store and the customers to use. The platform can be flexible and readily scalable so that the store can grow without undue commitments of time and effort. The platform can deliver promotional messages and continuously gather customer-related data through the customer communication. By building a database of customer endorsements, the platform can support marketing efforts of the store by allowing targeting of advertisements aimed at the customers.

In some embodiments, the present invention discloses a communication platform for performing social media activities between customers of a store, which can form an in-store social media. The platform can provide benefits to participating customers, such as giving to the customers an environment for engaging in discussion or in general, communication with other customers. The platform can also provide benefits by offering discounts or giving detailed information about the products or services of the store. Further, the platform can encourage interaction with the social media users, e.g., the customers in the store, to strengthen the store products or services and to market the store products or services to the customers.

The communications platform can also encourage and facilitate the voluntary participation of the customers. The communications platform can also support interaction with the customers to provide an effective and efficient mechanism to acquire information that is relevant to the interests and purchasing decisions of the customers.

In some embodiments, the communication platform functions as a social media server, e.g., for facilitating exchanges of communication between the customers in the store, and also between the customers and the store. For example, the store can invite the customers to provide feedback, regarding the services or products of the store. Incentives can be provided for receiving the feedback, such as discounts on next visits, or lottery for prizes. The in-store social media can provide a real time feedback for customers regarding the services or products of the store.

The in-store social media can also allow a customer to obtain and act on peer reviews by conducting in-store social survey. For example, a customer can want to get an opinion before, during, or after purchasing a product or service. The customer can post the question, e.g., including a picture of the product and related messages. The question can be sent to the in-store social media, such as to the platform, to be displayed on the display in the store.

In some embodiments, other customers can view the question and respond. The responses can be displayed on the display. The store can also respond, for example, if there are no customers answering the question, or if the answers are not clear. In some embodiments, the store can respond to a customer's question privately, e.g., to the customer who poses the question, rather than to other customers.

In some embodiments, the in-store customers, e.g., the customers inside the store or the potential customers at the entrance who contemplate of coming into the store, can have access to the in-store social media. One way to determine whether the customers are in-store customers can be through the locations of the customers, determined through the mobile devices of the customers. The mobile device can transmit positioning data through a positioning device such as a global positioning system (GPS), Bluetooth beacons, NFC or RFid devices. The customer device's positioning device can therefore provide data to allow the controller to determine whether or not the customers are inside the store or at the entrance, or in general, are in a vicinity of the store.

Another way to determine whether the customers are in-store customers can be through posting access information to the store network. The access information can be posted inside the store, or at the entrance of the store. Thus a customer can view the access information, and then use the access information to join the store network, while inside the store or while browsing the store at the entrance.

In some embodiments, the in-store social media, exemplified by the store or by a platform that the store operates, can accept registration of the users, e.g., of the customers of the store. The registration can allow the store to store profile information of the customers, and thus can specifically cater to the customers according to the profile. For example, the customers can automatically recognized when entering the store, for example, due to the registration to the in-store social media. Then using the customers profile information, the store can create specific messages that are tailored to the customers.

In some embodiments, the customer preferences can be determined using the customer online data and the historical customer in-store data. The in-store social media, exemplified by the store or by a controller, can generate or update a customer profile, for example, initially from the individual customer database, including customer online data and historical customer in-store data. The historical customer in-store data can identify the customer's previous in-store activities, as received from the controller. The platform could apply an artificial intelligence (AI) algorithm to analyze online customer data, social media data, and historical customer in-store data, together with actions taken by the customers to suggest possible appealing offers that the customer may be likely to want, and thereby increasing customer responses.

The store can also gather general customer data (i.e., data directly attributable to a specific customer). The store can generate advertisements and promotion of the store that specifically targeted the specific customers. The store, such as through the platform, can compile real-time data onto a business-facing dashboard to help the shop staff manage and track in-store customer interactions. For example, based on the services or products that the customers order, the store can generate advertisements or promotion based on the customers interest. The store can identify the customer and/or track activity of the customer within the store. The store can display a customized image or a customized description of a product or service based on the customer's past purchase.

In some embodiments, the in-store social media can be operated by an in-store social platform, e.g., a system that can perform activities of the in-store social media, such as sending messages to users of the in-store social media, e.g., the customer of the store, or receiving messages from the users.

The in-store social media platform can include a display and a controller, e.g., a platform controller. The display can be configured to be disposed inside a store. The display can be a device capable of exhibiting information, such as a monitor (e.g., LCD, LED display) or a screen (e.g., for showing information from a projector). The display and the controller can be two separate components, or can be integrated into one component. For example, a display can include a controller for communication with a network.

The platform controller can be a computing device or a data processing system such as a computer or a server, or in general, a system having a processor for processing commands, such as commands to show data on the display, or commands to process incoming communication from the customers of the store. The platform controller can be located at a remote computing facility, a cloud service facility such as Amazon AWS or Google cloud. The platform controller can be configured to process commands, such as having applications, e.g., software, running by the processor. The platform controller can be used to serve the needs or requests of other devices, e.g., devices of the users, such as mobile devices for the customers. The platform controller can be configured to process information related to products and/or services provided by the store. The platform controller can be configured to administer the social media activities of the in-store social media.

The platform controller can be configured to assist a customer in purchasing a product or in obtaining a service in the store. The platform controller can include a database, which can be used for storing information related to services and products of the store. For example, the store can display one or more suggestions or offers, including a suggested store product that the customer can be interested in based on the customer's past purchase or including potential discounts/current product promotions in effect at the store that relate to a customer's past purchase.

In some embodiments, the platform controller can be configured to accept inquiry from the customers, e.g., allowing the customers to solicit information with respect to a particular product, e.g., while the customers are in the store or even when the customers are outside of the store. In response, the controller can display answer or information related to the inquiry on the display or via software running on the customer's mobile device (smartphone). Reply can be via an app, such as FS Bot, on the customers smartphone. Customers may be in the store or outside of the store.

The process can be automatic, e.g., through a menu in which the customers can select information. The process can be manual, e.g., the customers can post questions and a personnel of the store, such as a manager, can compose the answer.

The controller can be configured to facilitate social media activities with the customers, e.g., among the customers and also between the customers and the store. The controller can be configured to be able to communicate with a network, such as the Internet or a cellular network. For example, the controller can include a media streaming device configured to stream media to the display from the network. The controller can impose a virtual reality or augmented reality layer on top of the images streamed to the display, for example, visual content and text can be overlaid onto an image of the physical space in the restaurant or retail shop.

The controller can be configured to communicate with the display, for example, to send files, e.g., pictures, video, or text messages, to the display to be displayed on the display. The controller can be configured to communicate with customers inside the store. The communication with the customers can be performed through mobile devices of the customers, with the mobile devices connected to the network that the controller is communicating with. In some embodiments, the display and the streaming device can be two separate components, or can be integrated into one component. For example, a display can have a built in controller or a built in streaming device for communication with a network.

The mobile devices of the customers can be electronic devices that can allow the customer to interact with the in-store social media, e.g., with the in-store social media platform or with the controller. The mobile device can be a portable electronic device, such as a smart phone, a cell phone, or other type of mobile computing device with wireless communication functionality, such as wifi or cell network connectivity. For example, the mobile device can be configured to be connected to the network through an internet network or a cellular network. The mobile device can communicate with the in-store social media, e.g., with the in-store social media platform or with the controller. For example, the customers can send his communication via the mobile device to be received by the store platform.

The communication of the in-store social media can be among the customers, and also can be between the customers and the store (or the in-store social media platform), e.g., a user representing the store. The store can have administration access, for example, to regulate and approve the communication in the in-store social media. For example, communications from the customers can be subjected to approval by the store, e.g., by a manager or a personnel of the store who monitors or administer the in-store social media activities. The controller can be configured so that communication from the customers can reach the store, e.g., the manager of the store, for example, coming to a mobile device of a manager of the store. The manager can review the communication, and can either approve or reject the communication to be posted on the in-store social media.

In some embodiments, the communication in the in-store social media can include the customers sending data, through the mobile devices of the customers, to the store, e.g., to the in-store social media platform or to the controller that is configured to administer the in-store social media activities. The data can include an image, photograph, a video, a voice message, a sound clip, a text message, or other combination of one or more types of media. The customers can communicate by at least one of taking pictures, taking a video, and composing a text, and sending to the in-store social media, e.g., to the store, to the in-store social media platform or to the controller, through the network.

In some embodiments, the communication in the in-store social media can include the store, e.g., the in-store social media platform or the controller that is configured to administer the in-store social media activities, sending data or information, e.g., pictures, video, voice, or text messages, to the display. The customers can view the display to receive the data or information. The customers can also receive the data or information via software running on the customers' smartphone or mobile device.

In some embodiments, the customers can also receive the data or information via Augmented Reality (AR) software running on the customers' smartphone or mobile device. The information to the customer could be sent to an AR app or Bot. The information would be appear as an overlay on top of a video image using the smartphone camera as input.

In some embodiments, the communication of the in-store social media activities can include one way communication between the customers and the store, including the customers sending data to the store through the mobile devices, and the store sending information to the customers through the display. For example, the one way communication can include the store sending information only to the display, e.g., the display cannot be functioned as a receiving device. The one way communication can also include the customers sending information through the mobile devices, and do not receive information through the mobile devices.

The one way communication mode can allow the customers to be anonymous, e.g., the customers can access the network, e.g., participated in the in-store social media, without any registration or without disclosing personal information. The store can configure the messages to be shown at the display to reach all customers, and not to any specific customers. The display can contain information related to individual customers, such as wishing happy birthday to a customer, but the message is broadcast to all customers in the store.

In some embodiments, the communication of the in-store social media activities can include two way communication between the customers and the store. The customers can send information to the store, e.g., through the mobile devices, and the customers can receive information from the store, e.g., also through the mobile devices. The store, besides sending information to individual customers through the mobile devices of the customers, can also send information to all customers in the store through the display. Thus the store can send messages designed for all customers, either through sending to all mobile devices or to the display. The store can send messages for selected customers through their mobile devices.

In some embodiments, to obtain two way communication, e.g., to receive individual messages from the store, the customers can register with the store, e.g., register with the in-store social media. The store can then use the registration data to directly communicate with the customers.

In some embodiments, the social media activities, e.g., the communication within the in-store social media, can include postings from the customers. For example, a customer can compose a message (e.g., taking a picture, writing a note, or a picture with a note) and then send the message to the store to be displayed on the display.

The social media activities can include an exhibit on the display. The exhibit can be a message or a communication from the store, which can serve to notify the customers of a message from the store, such as a store promotion or a store discount for a certain product or service, or to invite the customers to participate in an activity, such as a survey or a game.

The social media activities can include communication, e.g., messages, from the customers in respond to an exhibit, such as a message or an invitation, from the display.

In some embodiments, the store, e.g., the in-store social media and/or the in-store social media platform, can be configured to provide product and service review and advertisements for the store. The store can cooperate with other social media, and thus can show discussion and information about the store, e.g., about the store products or services. For example, the store can be connected to another social media such as Facebook, and can gather user reviews and endorsements from Facebook, to be display on the display in the store. For example, the controller of the in-store social media platform can be configured to display on the display of the in-store social media platform, information related to the store from a second social media. In some embodiments, the controller can format the information from the second social media before displaying.

In some embodiments, the store, e.g., the controller of the in-store social media platform, can be configured to display on the display advertisements related to products or services of the store.

In some embodiments, the present invention discloses a platform, which can be called an in-store social media platform, that can turn a physical store, such as a food service, a dining place, or a retailer shop, in to a real world social media space for customer interaction with the business. In some embodiments, the real world social media space can be called an in-store social media, with users, e.g., participants to the social media, being the customers in the store for discussing topics of interest to the store.

The in-store social media can be a social media, but with a user restriction, e.g., a social media only for customers in a store, such as inside the store or at an entrance of the store. The in-store social media can be administered by a personnel of the store, such as a manager of the store, to ensure that the communication of the in-store social media does not damage the image or reputation of the store operation, for example to prevent bad or malicious customer postings which could unfairly harm or damage the reputation of the store. Further, the personnel of the store can manage the in-store social media to keep the topics interesting, e.g., attracting attention of the customers to participate in the discussion.

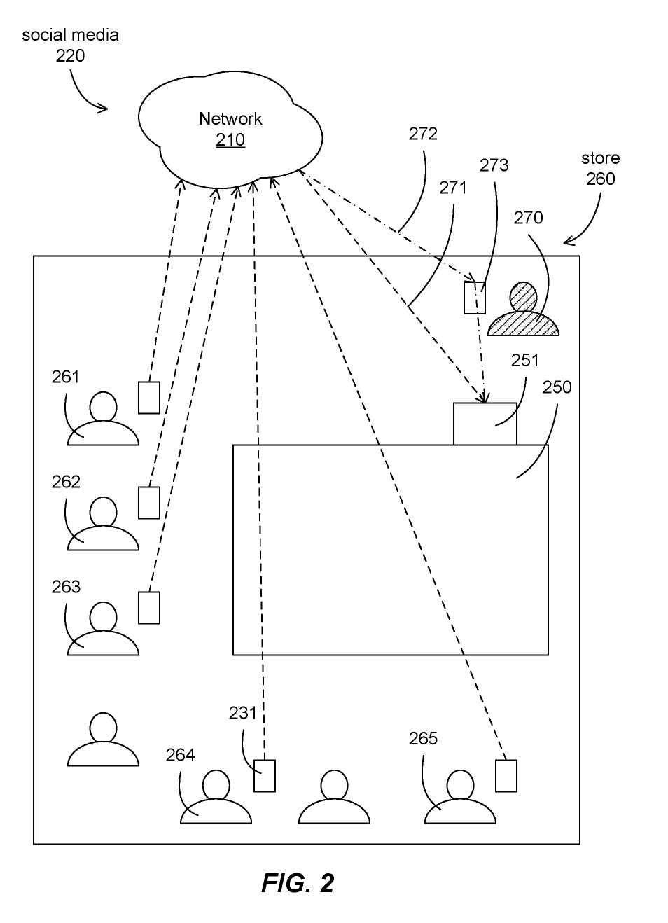

FIG. 2 illustrates a configuration of an in-store social media according to some embodiments. An in-store social media 220 can include multiple users 261-265 and optional user 270 participating in discussion through a network 210. The users 261-265 can include customers in a store 260, and thus the in-store social media can include mostly customers in the store. The in-store social media can optionally include the participation of user 270, which can be a personnel of the store, who can function as an admin for the in-store social media. User 270 can be in the store, or can be outside of the store.

Communication in the in-store social media 220 can include the customers 261-265 using their mobile devices, such as mobile device 231 of customer 264, to send, and optionally receive, messages to a social media platform, e.g., the in-store social media platform. The social media platform can include a display 250 disposed in the store 260. The display 250 can be used to transmit messages to the customers, e.g., communication to the customers can be performed through the display 250. The social media platform can include a controller 251, which can be attached to the display 250. The controller can be attached to an HDMI port of the display. Alternatively, the controller can be wirelessly attached.

In some embodiments, the platform can use a streaming server, such as a cloud-based streaming server, which can take postings from multiple social media sources and format and stream that content onto large screen displays in-store. The platform can use the streaming content on the in-store screen to compel the customer to respond and interact via one or more messaging bots for customer interaction.

The controller 251 is a streaming controller that is used to receive the streamed video signal from the controller located in the cloud server and present it to the screen for display. The controller can be configured to send messages to the display, in order to communicate with the customers, e.g., sending messages to the customers. The controller can be configured to communicate with the customers, e.g., to receive messages from the customers, and optionally to send messages to the customers, by connecting to a network 210. In some embodiments, different controllers can be used, such as a streaming controller for streaming media files to a display, and a social media platform controller for managing social media activities.

The customers can connect to the network 210, and can send messages to the network to be received by the controller. The controller can receive the customer messages, and then can display the messages on the display. Thus in some embodiments, communication between the customers and the store can include the customers sending messages to the network to be received by the controller, and the controller sending message to the display to be received by the customers.

In some embodiments, the controller can be configured to send messages directly and individually to the customers through the network, to be receive on the mobile devices of the customers.

In some embodiments, the social media platform can include a second controller, such as a mobile device 273 of a personnel 270, such as a manager, of the store. The personnel 270 can monitor and administer the traffic on the social media, such as reviewing and approving incoming communication to be display on the display of the social media platform. For example, communication from the customers can directly reach 271 the controller to be displayed on the display. Alternatively, communication from the customers can be sent to the 272 to the personnel, e.g., to the mobile device 273 of the personnel, so that the personnel can review and approve before forwarding to the controller to be displayed on the display.

The personnel 270 can also answer questions of the customers regarding to the products and/or services of the store. The personnel 270 can also guide the discussion, such as proposing topics of discussion among the customers that are of interest to the store.

In some embodiments, the present invention discloses methods for marketing products and services of a physical store, including engaging customers in the store in topics of interest to the store and to the customers. The methods can include a snap-and-cast feature, in which a customers can use a mobile device to snap a picture, and then can cast the picture, together with additional text messages, to the store. The methods can attract interests of the customers in the store, for example, by making the store become special to the customers. For example, the customers can post information on the display for other customers to see, such as through a snap-and-cast feature of the methods. The snap-and-cast feature can be based on a network among the customers in a store, or a network between the customers and the store, such as an in-store social media.

In some embodiments, the methods can include accepting communication from customers in a store, and displaying contents of the communication on a display in the store. The communication from the customers can include postings from the customers to be displayed on the display, such as a claim from a customer coming to visit the city, a notice of birthday or anniversary, or a comment on the good products or services of the store. The customers can use the mobile devices to send the communication, e.g., sending pictures, videos, and/or texts to be displayed.

In some embodiments, the customers and the display are connected to a same network, so that the communication from the customers can reach the display through the network. The display can be configured to accept communication from the network, for example, through a controller such as a media streaming device configured to stream media to the display from a network. The communication can be reformatted, e.g., changing the appearance and format, before being displayed. For example, the communication can be reformatted according to a format determined by the store before being displayed.

In some embodiments, the methods can include determining that the customers are in the store before accepting the communication from the customers. For example, locations of the customers can be determined through the GPS information, Blutetooth Wireless Beacons or NFC proximity detection devices in the customer mobile devices to determine that the customers are in a vicinity of the store. Alternatively, a network access can be posted inside the store for the customers to see if the customers are in the store. The customers then can access the network that the display is connected to, and can send communication to the network to the display. Thus the customers can be determined to be inside the store by the ability to access the network.

In some embodiments, the communication can be an one way communication in which the customers send information to the store through mobile devices of the customers to the display, and the store sends information to the customers through the display.

In some embodiments, the methods can include reviewing the communication by a person or by a data processing system before displaying the contents of the communication.

In some embodiments, the methods can include a capability of the store to send messages to the customers. For example, the store can show an exhibit on the display, with the exhibit serving to notify the customers of a message from the store or to invite the customers to participate in an activity. The message can include an advertisement of the store, such as a discount for certain products or services. The message can include information related to the store from a social media or information related to products or services of the store. The invitation can serve to engage the customers in topics of interest to the store and the customers, such as proposing a game or a survey.

In some embodiments, the communication from the customers can include communication from the customers in respond to a message from the display, or communication from the customers in respond to an exhibit on the display.

In some embodiments, the methods can be performed by a social media platform, which can include a display disposed in a store, together with a platform controller for communication with users, e.g., with the customers of the store. The platform controller can initiate activities, such as running a game or a survey, showing a store promotion, or inviting the customers to contribute to the activities. The store can appoint an operator, such as a manager of the store, to manage the store social media. The social media platform can include mobile devices of the customers, through which the customers can snap pictures or video, and can compose comments for casting to the display. The customers can participate in the activities proposed by the store. The customers can start their own activities, such as casting or posting comments to the store social media, or challenging other customers to an activity

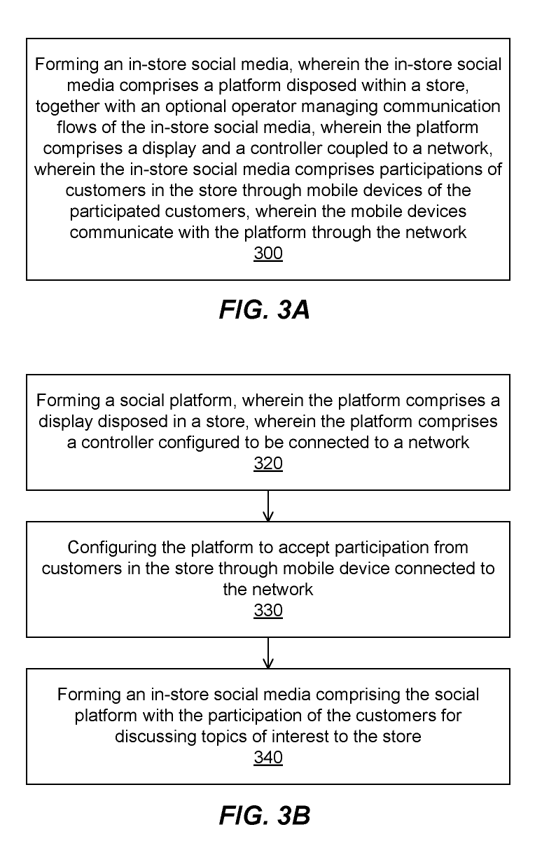

FIGS. 3A-3B illustrate flowcharts for forming a network of customers in a store according to some embodiments. In FIG. 3A, operation 300 forms an in-store social media, wherein the in-store social media comprises a platform disposed within a store, together with an optional operator managing communication flows of the in-store social media. The platform can be located in a remote cloud facility, such as a server located at a shared computing facility like Amazon AWS. The platform comprises a display and a controller coupled to a network, wherein the in-store social media comprises participations of customers in the store through mobile devices of the participated customers, wherein the mobile devices communicate with the platform through the network.

In FIG. 3A, operation 320 forms a social platform, wherein the platform comprises a display disposed in a store, wherein the platform comprises a controller configured to be connected to a network. Operation 330 configures the platform to accept participation from customers in the store through mobile device connected to the network. Operation 340 forms an in-store social media comprising the social platform with the participation of the customers for discussing topics of interest to the store.

In some embodiments, the in-store social media can promote interests in the customers, such as providing activities for the customers, for example, while the customers are waiting to be served in a restaurant, or waiting for the store to complete the service in a car repair shop.

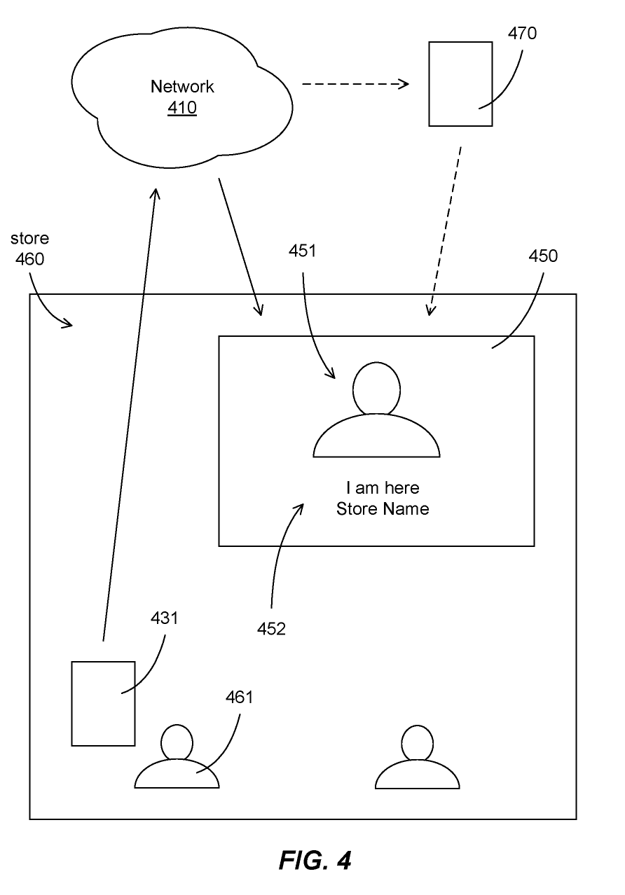

FIG. 4 illustrates a configuration of a snap-and-cast feature according to some embodiments. The snap-and-cast feature can be included in an in-store social media, e.g., for the customers in a store to engaging with each other. A visitor 461 from out of town can visit a store 460. The visitor can use his mobile device 431 to take his picture and to compose a message before sending to a network 410 to reach a display 450 in the store. The picture 451 and the message 452 can be shown on the display 450. An optional operator can review and approve the posting of the visitor, for example, through a mobile device 470.

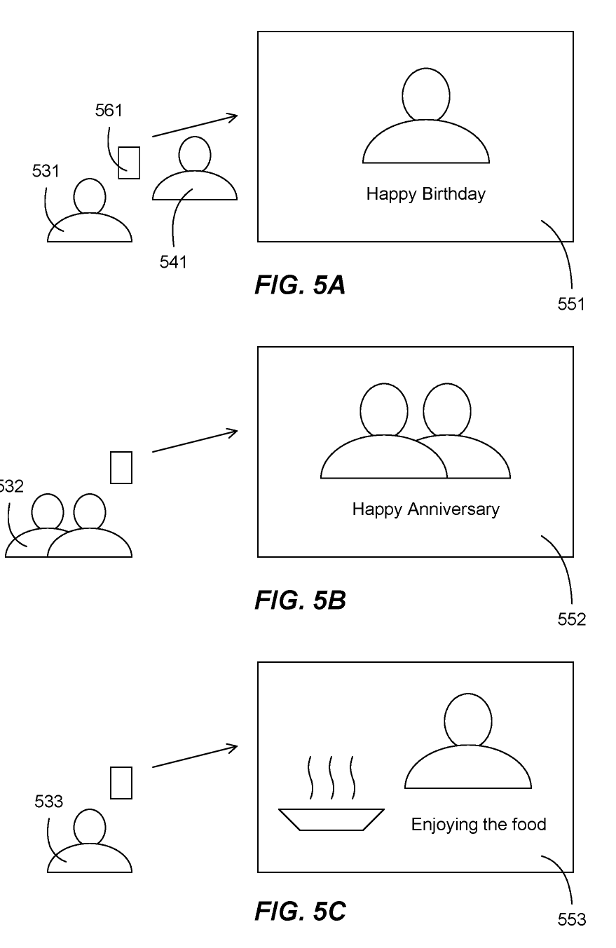

FIGS. 5A-5C illustrate other configurations of a snap-and-cast feature according to some embodiments. In FIG. 5A, a customer 531 can wish a friend 541 happy birthday, by using mobile device 561 to take picture of the friend 541 to post on the store display 551. The customer can wish himself a happy birthday by taking his own picture to send.

In FIG. 5B, a couple 532 can snap and cast their picture on the display 552 to celebrate their anniversary. The couple can ask a waiter or a friend to take their picture with their mobile device before casting to the display. In FIG. 5C, a customer 533 can use a mobile device to take a picture of the food, and optionally his picture to post on the store display 553.

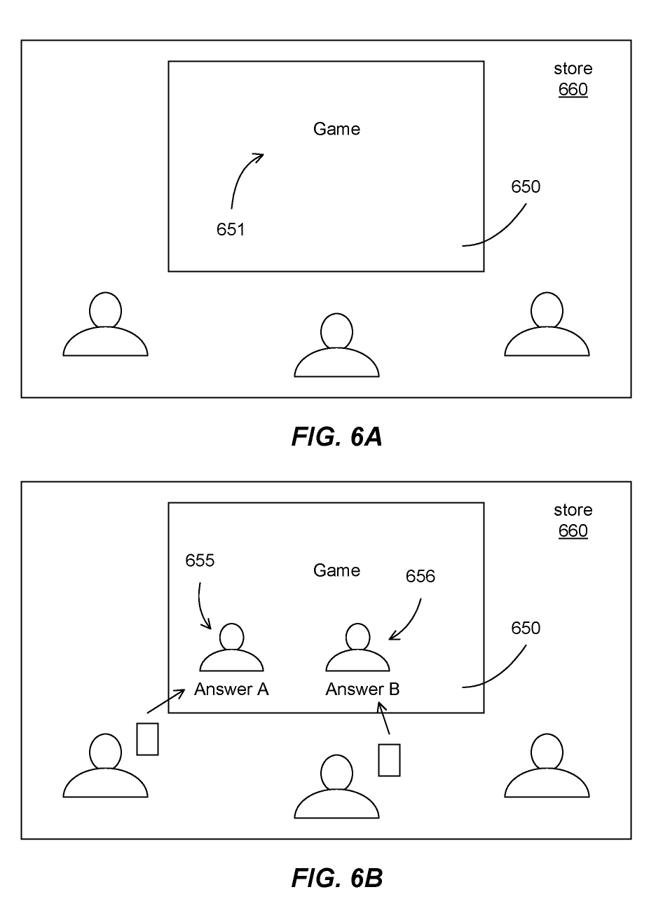

FIGS. 6A-6B illustrate a configuration of customers participating in a store activity according to some embodiments. In FIG. 6A, the store 660, e.g., the controller under the operation of a personnel of the store, can display a message 651 on the display 650, such as an invitation to the customers in the store to participate in a game. In FIG. 6B, the customers can use their mobile devices to send messages 655-656, which can be displayed on the display 650, for example, in response to the game invitation from the store.

In some embodiments, the store can use the display to promote products and services of the store. For example, the store can offer discounts for certain products and services.

In some embodiments, the store can cater the messages to specific customers. The messages can be displayed for all customers to see, but the contents of the messages can be specific to certain customers in the store. For example, a group of customers have been having a party in a section of the food store. By knowing the food served, and the demographic of the customers, a manager of the store can formulate an advertisement specifically targeting the group of customers. For example, the store can show a message on the display, telling the customers a special deal of the day, in which customers can receive a discount for order above a certain value.

Other configurations can be used, such as a survey, or promotional messages, notifying the customers of special orders of the day.

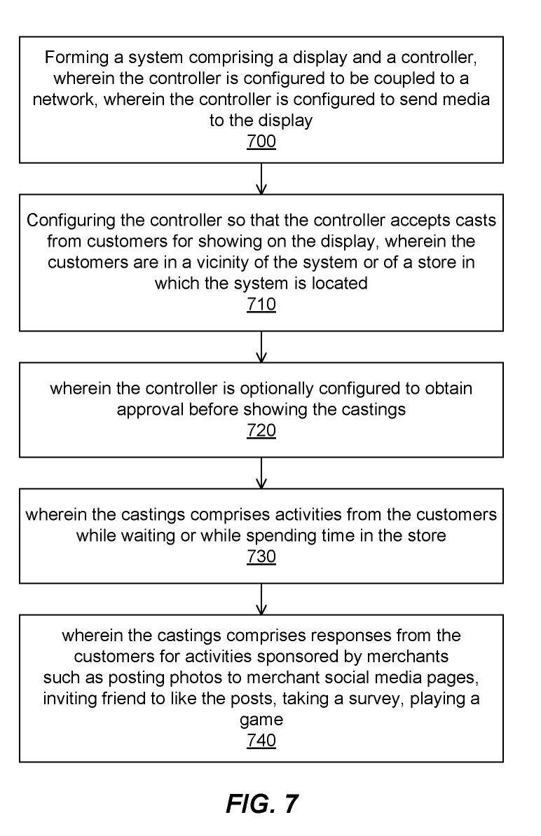

FIG. 7 illustrates a flowchart for forming a system to engage customers in a store according to some embodiments. Operation 700 forms a system comprising a display and a controller, wherein the controller is configured to be coupled to a network, wherein the controller is configured to send media to the display. Operation 710 configures the controller so that the controller accepts casts from customers for showing on the display, wherein the customers are in a vicinity of the system or of a store in which the system is located.

In operation 720, the controller can be optionally configured to obtain approval before showing the castings. In operation 730, the castings can include activities from the customers while waiting or while spending time in the store. In operation 740, the castings can include responses from the customers for activities sponsored by merchants, such as posting photos to merchant social media pages, inviting friend to like the posts, taking a survey, playing a game.

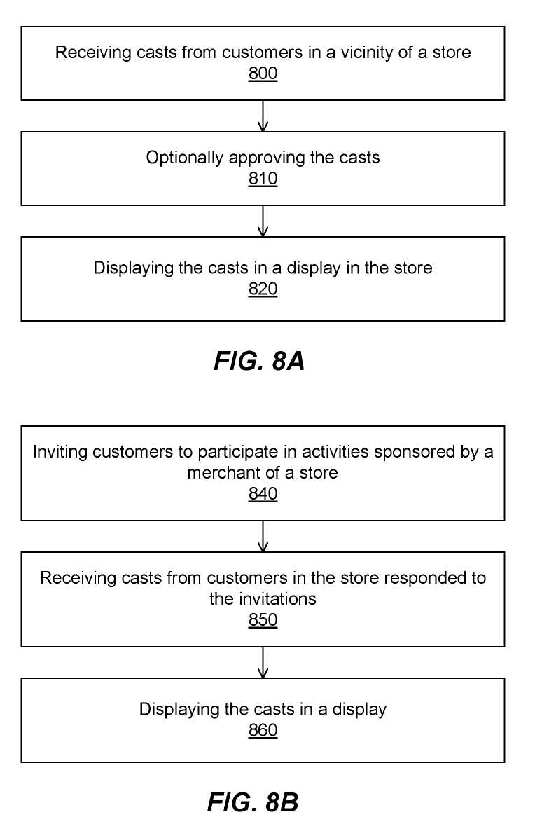

FIGS. 8A-8B illustrate flowcharts for performing activities from customers in a store according to some embodiments. In FIG. 8A, a customer can snap a picture, compose a message, and then cast the picture and message to a display in a store. The snap-and-cast can be for the customer interest, similar to a selfie feature with mobile devices. For example, in a restaurant, the customers can snap-and-cast while waiting for food, or doing something during eating. The snap-and-cast can serve as a memory preserver, such as showing that you are at the store. The snap-and-cast can include friends, showing the friendship on the store display. The snap-and-cast can include the food.

Operation 800 receives casts from customers in a vicinity of a store. Operation 810 optionally approves the casts. Operation 820 displays the casts in a display in the store.

In FIG. 8B, customers can snap-and-cast in response to a challenge from the store, such as a game inviting customers in the store to participate, or a survey. The customers can snap-and-cast for getting prizes offered by the store, such as posting message in facebook, like the store, or inviting friends to like posts about merchants. Operation 840 invites customers to participate in activities sponsored by a merchant of a store. Operation 850 receives casts from customers in the store responded to the invitations. Operation 860 displays the casts in a display.

In some embodiments, the present invention discloses a social media for in-store platform, to bring online data to in-store business. An in-store platform can be connected to a social media, which can be contributed by users all over the world through a network such as the Internet. The users can discuss multiple topics, including discussion about the store. The in-store platform can select the discussion related to the store, and can display these discussions in a display in the store, for example, to show the customers inside the store that the products and services of the store have been getting good reviews. The social media can be recent, such as within a few days or a few weeks, to show that the information is not outdated.

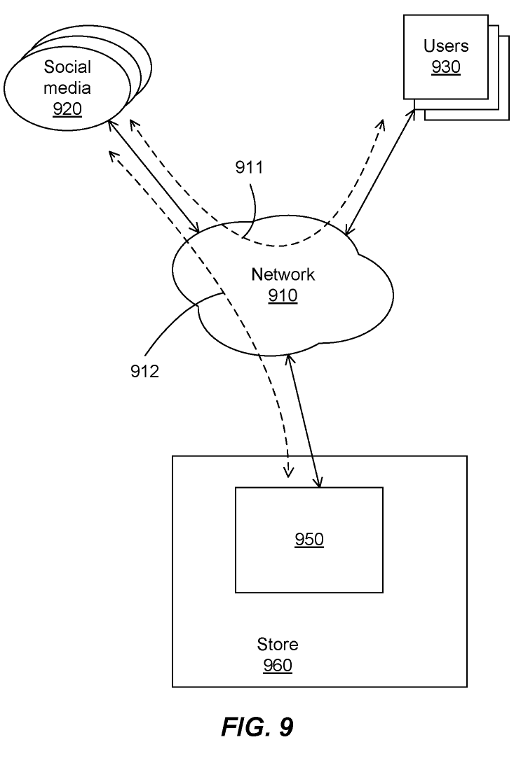

FIG. 9 illustrates a configuration of an in-store platform according to some embodiments. A store 960 can have a display 950 disposed in the store, such as inside the store or at the entrance of the store. The display 950 can be coupled to a network 910, which can link the display 950 to one or more social media 920.

The social media 920 can be contributed 911, e.g., participated in discussion, by users 930. The display 950 can select the discussion that are related to the store, such as discussion related to the store products or services. The thread related to the store from the social media 920 can be forwarded 912 to the store, e.g., to the display 950 to be displayed on the display. The information from the social media 920 can served as an advertisement for the store, to show the customers in a vicinity of the store, e.g., the customers already in the store, or the potential customers thinking about entering the store. Other components can be included, such as a media streaming device configured to stream data from the network to the display.

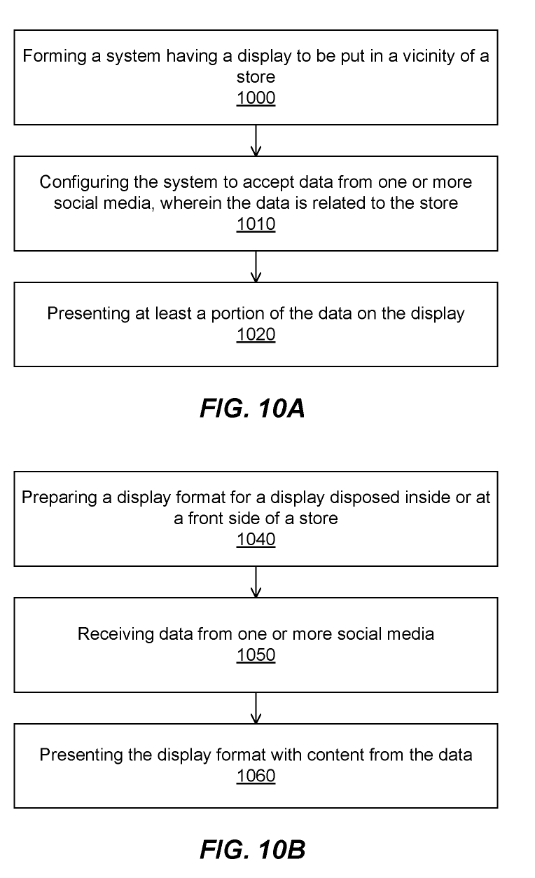

FIGS. 10A-10B illustrate flowcharts for forming in-store platforms according to some embodiments. In FIG. 10A, operation 1000 forms a system having a display to be put in a vicinity of a store. Operation 1010 configured the system to accept data from one or more social media, wherein the data is related to the store. Operation 1020 presents at least a portion of the data on the display.

In FIG. 10B, operation 1040 prepares a display format for a display disposed inside or at a front side of a store. Operation 1050 receives data from one or more social media. Operation 1060 presents the display format with content from the data.

In some embodiments, the in-store platform can include a controller for controlling the display, e.g., regulating the data coming to the display or formatting the data to conform to the store specification, such as adding the store logo. The in-store platform can also include a storage for storing data, such as information about the store products and services, information about present or future promotion and discounts.

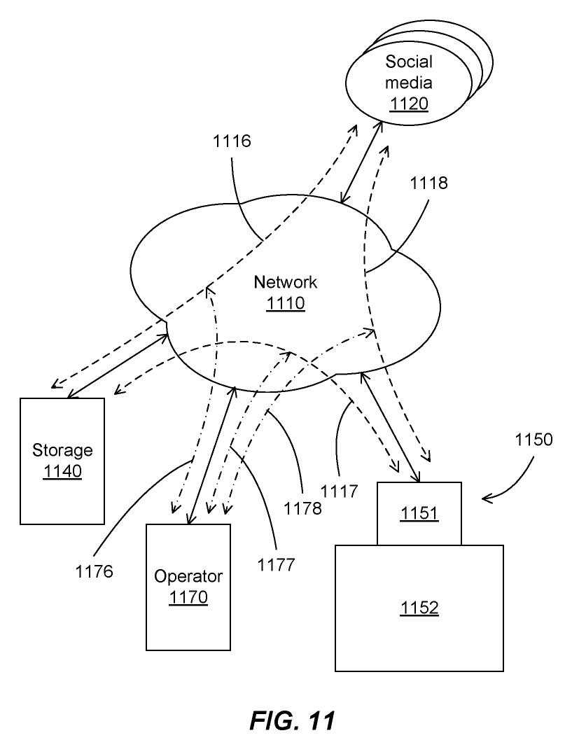

FIG. 11 illustrates a configuration for an in-store platform according to some embodiments. A platform, e.g., a social media in-store engagement platform, can be configured to gather data from social media, such as Facebook, and to display the data in a store to facilitate the engagement of the customers in the store. A platform 1150 can include a display 11052 and a controller 1151 coupled to the display. The platform can be placed in a vicinity of a store, such as inside the store or at an entrance of the store. The platform can function as a digital signage system, e.g., a computer controller billboard for display advertisements for the store. In addition to the store-generated advertisements, the platform can display reviews, suggestion, and endorsements from people from all over the world, e.g., from users of social media discussing the products and services of the store.

In some embodiments, content of social media 1120 can be streaming directly 1118 to the controller 1151, e.g., a media streaming device, to be displayed on the display 1152. The streaming data can be optionally controlled 1178 by an operator 1170 such as selecting content that are related to the store.

In some embodiments, an optional storage 1140 can be included. Content of social media 1120 can be collected 1116 in the storage 1140, through a network 1110 (e.g., the Internet). The collected content can be controlled 1176 by an operator 1170, such as selecting content that are related to stores. After being approved by the operator, the controller 1151 can be configured to receive 1117 data from the storage 1140 through the network 1110.

The operator 1170 can control 1177 both the storage 1140 and the controller 1151. For example, the operator can tell the storage 1140 about the format and content to send to the controller 1151. The operator can configure the controller to accept data from the storage.

In some embodiments, the storage can be integrated with the controller 1151, e.g., hardware to the controller, or connected to the controller through a local network. Thus the platform 1150 can be independently controlled, for example, by the store itself. Further, this configuration can allow disruption from network 1110, e.g., contents to be display can come directly from the storage, which is local to the display.

The operator can also be integrated with the controller, and can configure the platform at the controller location. The operator can be separate, such as a smart phone or a computer linking to the controller, e.g., linking through the network. The operator can be near the controller, or can be anywhere.

The storage can be separate, e.g., linking to the controller through the network. That way a storage can serve multiple systems, for example, by a company servicing multiple stores. The controller can have a buffer, e.g., a local storage, for working when there is disruption from the network. The operator can be separate, such as a smart phone or a computer linking to the controller and the storage, e.g., linking through the network.

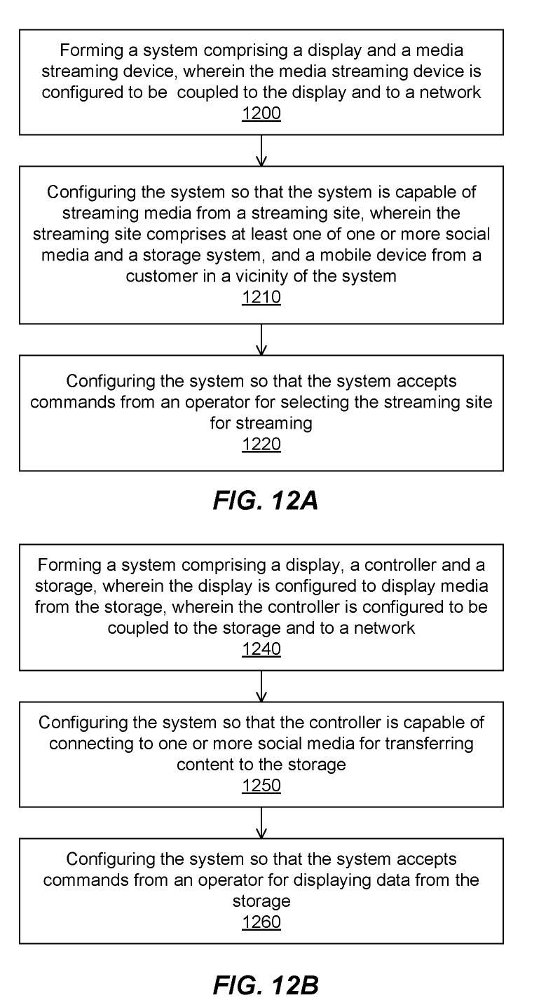

FIGS. 12A-12B illustrate flowcharts for forming in-store platforms according to some embodiments. In FIG. 12A, operation 1200 forms a system comprising a display and a media streaming device, wherein the media streaming device is configured to be coupled to the display and to a network. Operation 1210 configures the system so that the system is capable of streaming media from a streaming site, wherein the streaming site comprises at least one of one or more social media and a storage system, and a mobile device from a customer in a vicinity of the system. Operation 1220 configures the system so that the system accepts commands from an operator for selecting the streaming site for streaming.

In some embodiments, the system can be configured so that the system accepts data from customers in a vicinity of the system to put in the storage system for streaming. The system can be configured so that the system accepts casts from customers in a vicinity of the system.

In FIG. 12B, operation 1240 forms a system comprising a display, a controller and a storage, wherein the display is configured to display media from the storage, wherein the controller is configured to be coupled to the storage and to a network. Operation 1250 configures the system so that the controller is capable of connecting to one or more social media for transferring content to the storage. Operation 1260 configures the system so that the system accepts commands from an operator for displaying data from the storage.

In some embodiments, the system can be configured so that the system accepts data from customers in a vicinity of the system to put in the storage system for streaming. The system can be configured so that the system accepts casts from customers in a vicinity of the system.

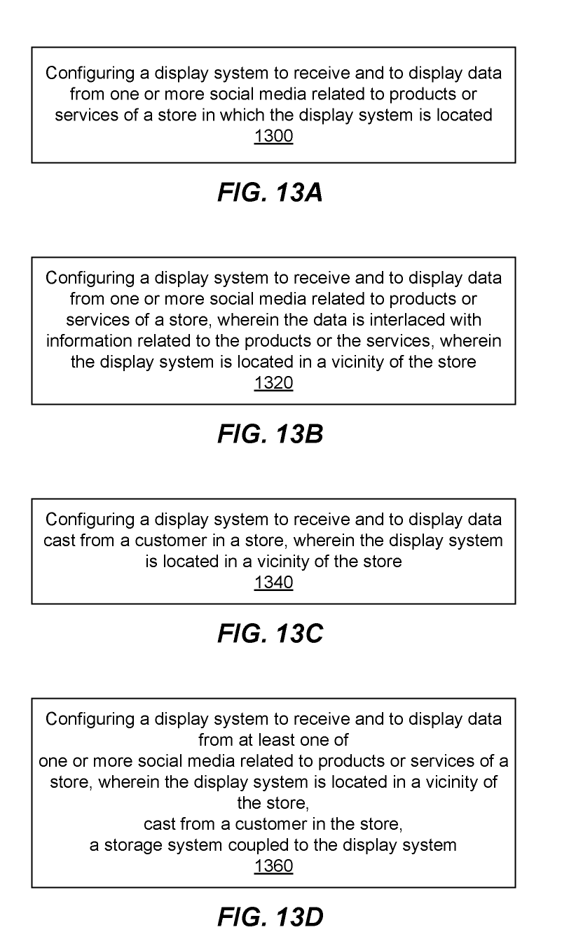

FIGS. 13A-13D illustrate flowcharts for configuring in-store platforms according to some embodiments. In FIG. 13A, operation 1300 configures a display system to receive and to display data from one or more social media related to products or services of a store in which the display system is located.

In FIG. 13B, operation 1320 configures a display system to receive and to display data from one or more social media related to products or services of a store, wherein the data is interlaced with information related to the products or the services, wherein the display system is located in a vicinity of the store.

In FIG. 13C, operation 1340 configures a display system to receive and to display data cast from a customer in a store, wherein the display system is located in a vicinity of the store.

In FIG. 13D, operation 1360 configures a display system to receive and to display data from one or more social media related to products or services of a store, wherein the display system is located in a vicinity of the store, from cast from a customer in the store, from a storage system coupled to the display system, or from a combination thereof.

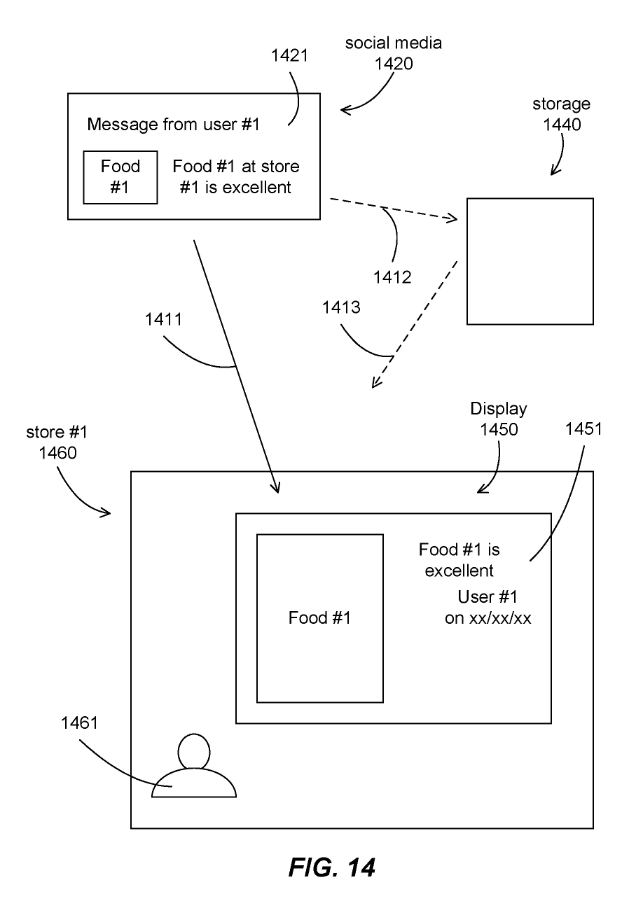

FIG. 14 illustrates an example of a service of an in-store platform according to some embodiments. A store #1 1460 can have a platform installed in the store. The platform can include a display 1450, with the display configured to stream media from a network, such as from the Internet. For example, the display can be a smart television, which includes screen for displaying information, and a controller to processing information from a network, such as the Internet, a cellular network, or a satellite network. The display can be a monitor with a controller configured to process data from the network, such as a media streaming device. The in-store platform can communicate with one or more social media, and can collect postings from users of the social media that are related to the store to be used in the in-store platform, such as using reviews and recommendations of the social media for advertising the store products or services.

In operation, communication 1421 from social media 1420 can be sent 1411 to the display, to be displayed as a message 1451 on the display in the store 1460. The message 1451 can be viewed by the customers 1461 in the store, which can serve as an endorsement for a product or for a service of the store. The message 1451 can include the name of the person who performs the assessment, thus can provide authentication for the message. The message 1451 can include the date of the posting of the communication, such as 1, 5, or 10 days ago, thus can provide a time stamp for the message, indicating that the assessment is a recent assessment.

In some embodiments, the communication 1421 can be sent 1412 to a storage 1440 before re-routing 1413 to the display. The communication can be stored in the storage, and can be used in formulating promotion or advertisement of the products or services of the store. For example, in showing a product or service, the store can display multiple assessments from the social media 1420, indicating a well-known and well-like condition of the product or service among the online community.

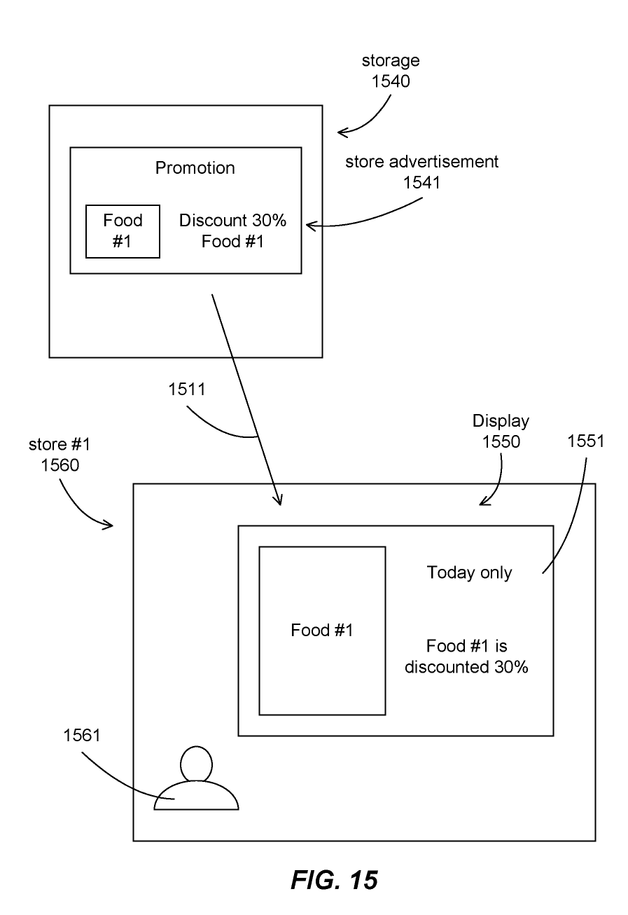

FIG. 15 illustrates an example of a service of an in-store platform according to some embodiments. The in-store platform can be used for posting promotion and advertisement. Store advertisement 1541 can be stored in a storage 1540. The advertisement 1541 can be sent 1511 to the display, to be displayed as a message 1551 on the display in the store 1560. The message 1551 can be viewed by the customers 1561 in the store, which can publicize the products or services of the store.

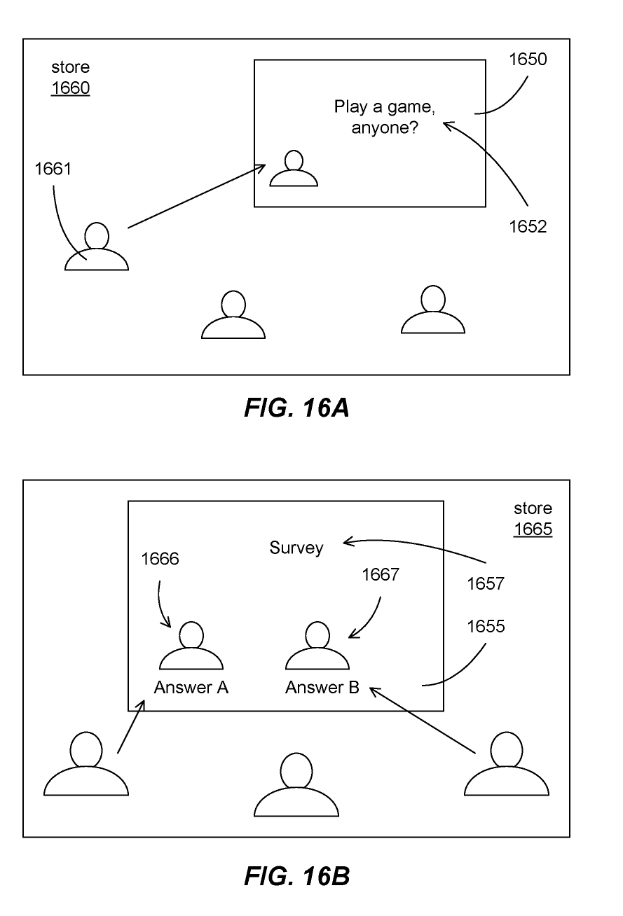

FIGS. 16A-16B illustrate examples of a service of an in-store platform according to some embodiments. The in-store platform can be used for engaging customers in the store in some activities. The participation in the activities can provide a long lasting impression of the store onto the customers. In FIG. 16A, a customer 1661 in a store 1660 can post an invitation 1652 on a display 1650 for a game. For example, the customer can take a picture of himself and compose an invitation and then send to the store to be displayed. Other customers can use a snap-and-cast feature of the in-store platform to respond, e.g., to participate in the game.

In FIG. 16B, a store 1665 can post a message 1657, such as a survey, on a display 1655, and then invite the customers to participate. In some embodiments, the store can offer incentive for the customers to participate, for example, by providing discounts or promotion to the participating customers. The customers can answer the survey, and the answers 1656, 1657 can be posted on the display.

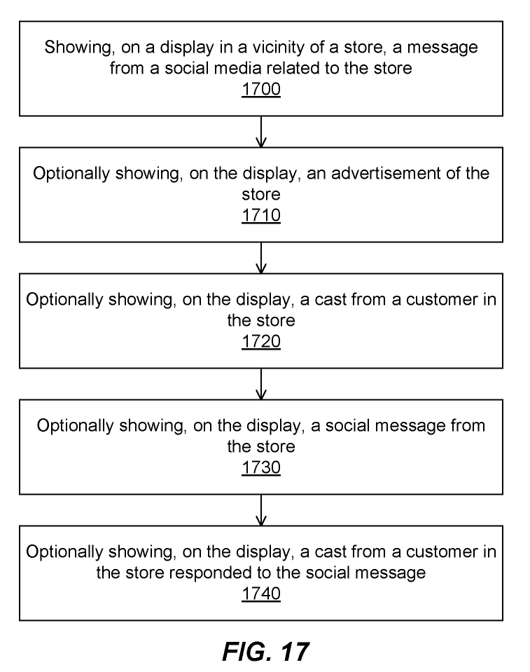

FIG. 17 illustrates a flowchart for operating a platform to increase engagements of customers according to some embodiments. Operation 1700 shows, on a display in a vicinity of a store, a message from a social media related to the store. In operation 1710, there is an optionally showing, on the display, an advertisement of the store. In operation 1710, there is an optionally showing, on the display, a cast from a customer in the store. In operation 1710, there is an optionally showing, on the display, a social message from the store. In operation 1710, there is an optionally showing, on the display, a cast from a customer in the store responded to the social message.

In some embodiments, the present invention discloses a system that can be used for promoting customer interest in a store. The system can be placed in the store, and can be used for communication among the customers in the store and optionally for communication between the customers and the store.

In some embodiments, the system can include a display, which can be placed inside a store and/or at an entrance of the store. The system can include multiple displays. The multiple display can all show a same message. The multiple display can show different messages, e.g., at least two displays showing two different messages.

The system can include a controller, such as a computing system or a data processing system, including a desktop computer, a laptop computer, a server, or a mobile device. The controller can be configured to be able to connect to a network, such as an Internet network or a cellular network. The network connection can allow the controller to be linked to other systems.

The controller can be configured to be able to communicate with customers inside the store, e.g., in a vicinity of the store in which the display is located. The customers can have mobile devices, which can be connected to the network that the controller is able to connect to. Thus the customers and the controller can be linked through the network, and thus can be able to communicate, e.g., among the customers or between the customers and the controller. The communication between the customers and the controller through the network can be one way communication, e.g., only from the customers to the controller. The communication between the customers and the controller through the network can be two way communication, e.g., from the customers to the controller, and from the controller to the customers.

The controller can be configured to communicate with the display, e.g., to be able to display, on the display, data from a memory of the controller, such as the communication with the customers that the customers want to be display on the display, or messages that the store wants to show the customers. The information on the display can be seen by the customers in the store. The controller and the customers can post messages on the display. For example, the customers can send messages to the controller through the network, so that the controller can show the messages on the display. The controller can send messages directly to the display.

The communication between the customers and the controller through the display can be one way communication with one source and many recipients. A customer can post a message on the display for all customers to see. Or the store, through the controller, can show a message on the display.

In some embodiments, the characteristics described above with respect to the in-store social media and the in-store social media platform can be applicable to the system, such as the communication with the customers can include postings from the customers, the communication from the controller can include an exhibit on the display, which can include a message or a communication from the store, and the communication with the customers can include messages from the customers in respond to an exhibit from the display. The controller can include a media streaming device. The customers can be determined to be inside the store by accessing locations of the customers through the mobile devices. The customers are determined to be inside the store by the customers accessing the network through a network access posted inside the store. The customers can communicate with the system by taking pictures, taking a video, or composing a text, and sending to the system through the network by the mobile devices of the customers.

In some embodiments, the system can include a mobile device from a personnel, such as a manager, of the store. The personnel can function as an admin of the system, e.g., to monitor and administer the communication between the customers and the store. For example, the communication from the customers can be reviewed by the personnel, such as needing approval from the personnel before getting posted on the display.

In some embodiments, the system can be configured to provide product and service review and advertisements for the store. The system can cooperate with one or more social media, and thus can show discussion and information about the store, e.g., about the store products or services. For example, the system can be connected to a social media such as Facebook, and can gather user reviews and endorsements from Facebook, to be display on the display in the store. For example, the controller of the system can be configured to display on the display, information related to the store from a second social media or from multiple social media. In some embodiments, the controller can format the information from the social media before displaying.

In some embodiments, the system can be configured to display on the display advertisements related to products or services of the store.

What is claimed is:

1. A platform for in-store social media activities, the platform comprising
a display, wherein the display is configured to be disposed inside a store;
a controller,
wherein the controller is configured to be able to connect to a network,
wherein the controller is configured to communicate with the display,
wherein the controller is configured to communicate with customers inside the store through mobile devices of the customers connected to the network,
wherein the controller is configured to facilitate social media activities with the customers through the display.

2. A platform as in claim 1
wherein the social media activities comprise at least one of
postings from the customers to be displayed on the display,
an exhibit on the display, notifying the customers of a message from the store or inviting the customers to participate in an activity,
communication from the customers in respond to a message from the display,
communication from the customers in respond to an exhibit on the display.

3. A platform as in claim 1
wherein the in-store social media activities comprise activities between the customers inside the store and the platform.

4. A platform as in claim 1
wherein the social media activities are subjected to approval from a personnel of the store.

5. A platform as in claim 1 further comprising
a data processing system for administer the social media activities.

6. A platform as in claim 1
wherein the controller comprises a media streaming device configured to stream media to the display from the network.

7. A platform as in claim 1
wherein the customers are determined to be inside the store by accessing locations of the customers through the mobile devices, or by the customers accessing the network through a network access posted inside the store.

8. A platform as in claim 1
wherein the communication of the in-store social media activities comprises an one way communication in which the platform sends information through the display and an one way communication in which the customers send information through the mobile devices.

9. A platform as in claim 1
wherein the controller is configured to display on the display information related to the store from multiple media

10. A platform as in claim 1
wherein the controller is configured to display on the display advertisements related to products or services of the store.

11. A system comprising
a display, wherein the display is configured to be disposed inside a store;
a controller,
wherein the controller is configured to be able to connect to a network,
wherein the controller is configured to be able to communicate with customers inside the store through mobile devices of the customers connected to the network,
wherein the controller is configured to be able to display contents of the communication with the customer to the display.

12. A system as in claim 11
wherein the communication with the customers comprise at least one of
postings from the customers to be displayed on the display,
an exhibit on the display, notifying the customers of a message from the store or inviting the customers to participate in an activity,
communication from the customers in respond to a message from the display,
communication from the customers in respond to an exhibit on the display.

13. A platform as in claim 11 further comprising
a mobile device for administer the communication with the customers.

14. A system as in claim 11
wherein the controller is configured to receive and display on the display information related to the store from a social media.

15. A system as in claim 11
wherein the controller is configured to receive and display on the display advertisements related to products or services of the store.

16. A method comprising
accepting communication from customers in a store;
displaying contents of the communication on a display, wherein the display is disposed in the store.

17. A method as in claim 16 further comprising
displaying an exhibit on the display, wherein the exhibit serves to notify the customers of a message from the store or to invite the customers to participate in an activity.

18. A method as in claim 16
wherein the communication from the customers comprise at least one of
postings from the customers to be displayed on the display,
communication from the customers in respond to a message from the display,
communication from the customers in respond to an exhibit on the display.

19. A method as in claim 16
wherein the communication between the customers and the display comprises an one way communication in which the display sends information through the display and an one way communication in which the customers send information through mobile devices of the customers.

20. A method as in claim 16 further comprising
displaying an exhibit on the display, wherein the exhibit comprises information related to the store from a social media or information related to products or services of the store.
